(19) United States
(12) Patent Application Publication
(10) Pub. No.: US 2016/0110939 A1
(43) Pub. Date: Apr. 21, 2016

(54) Security Locking System and Method for Safe Systems

(71) Applicants: Bob M. Dobbins, Villanova, PA (US); Thomas Carullo, Marlton, NJ (US)

(72) Inventors: Bob M. Dobbins, Villanova, PA (US); Thomas Carullo, Marlton, NJ (US)

(73) Assignee: ELLENBY TECHNOLOGIES, INC., Woodbury Heights, NJ (US)

(21) Appl. No.: 14/515,788

(22) Filed: Oct. 16, 2014

(51) Int. Cl. G07C 9/00; E05B 47/00

(52) U.S. Cl. CPC G07C 9/00174; E05B 47/0001; E05B 47/0012

(57) ABSTRACT

A locking system for safes is described. An electronic lock is described having an electronic actuator mounted independent of a door of the safe. Power is delivered to the electronic actuator by a door independent power delivery system so that no battery is required in the door, no electrical wires go to the door and no other power arrangement is needed to provide power to the door. The electronic activator when activated interacts with a door mounted mechanical feature, such as passing through a lock tongue hole, and then engage a lock clearance hole or slot which is also mounted independently of the safe door. This approach allows one safe design employing an electronic lock to be used with a different door to include a further mechanical lock to provide a two lock approach or a single door with an unlocked handle where two different locks are not desired.

### FIELD OF THE INVENTION

The present invention relates generally to improvements in the security of the locking system used for safes. In particular, the present invention relates to an improved electronic lock system to improve security, eliminate the need for electrical wiring on the door or doors of the safe and creating a very reliable, low cost solution.

### BACKGROUND

The current state of the art for secure electronic locking solutions in security applications is to use a commercially available lock that operates independently or in conjunction with a bolt work arrangement. Historically, a locking mechanism may include the option of using both a key and an electronic option to further increase the security of the system or require two levels of authority to gain access. Typical locking mechanisms use a solenoid or motor to electrically release a latch that enables the door to be opened directly or enables a key lock to turn if dual levels of authority are needed. Such a lock system can be seen in Stefanek U.S. Pat. No. 4,593,543 (Stefanek). In this patent, Stefanek specifically addresses allowing the electronic option to be fail safe or fail secure. Nonetheless, the solenoid and key are housed in a common assembly as seen in Stefanek FIG. 1A, for example, and described at col. 7, lines 30-38. The described lock assemblies require power to be brought to the lock assembly to power the solenoid or motor.

More traditionally, the electronic locks used for safe systems are commercial lock assemblies such as the Kaba Mas model 3058E000-00-06 electronic lock assembly. This class of lock assembly is self-contained and includes the solenoid or motor within the assembly. These electronic lock assemblies can be used directly to lock the safe doors or for additional security they are typically designed into the bolt work assembly. These commercial electronic lock assemblies can be used with or without a dual access mechanical key.

The existing technology addressed above suffers from several disadvantages. When using a smart safe or other safe with a power source inside, a major disadvantage is that at least the power to energize the solenoid or motor within the lock assembly has to be brought to the lock assembly which is mounted on the inside of the door. In the simplest configuration, power alone is brought to the door requiring an at least two conductor (power and return) wire harness to be brought to the door and connected to the lock. Insofar as the door is opened and closed, great care has to be taken to dress the wire harness to avoid failure through fatigue or through inadvertent disconnection. Either of these conditions would render the door inoperable and would require a skilled lock technician to break into the safe.

Another disadvantage of using the two conductor wire harness approach is the ease with which access to these wires (through drilling a strategically placed hole, pre-meditated slicing to these wires or access directly from the controller normally energizing the electronic lock) may allow a thief to open the safe. In order to minimize this potential point of attack, additional electronics can be added to the lock assembly requiring a communication link to the lock so power alone will not open the lock. This adaptation means additional conductors (beyond the power and return lines) in the wire harness are required. Of course, if more wires are brought to the door, there is a higher risk of damaging one or more of the wires, rendering the lock inoperable.

A further disadvantage of such approaches is the security of the relatively small and unprotected components used within these electronic lock systems. In order to prevent thieves from accessing the locks, added re-enforcement is often added to increase the strength of the door and buttress the protection provided around the lock assembly.

### SUMMARY OF THE INVENTION

Aspects of the current invention address several shortfalls of the above addressed electronic lock technology. One important objective of the current invention is to separate the mechanical aspects of the lock from the electrical aspects of the lock.

Another objective of the current invention is to simplify and improve the ruggedness of both the mechanical aspects of the lock as well as the electrical aspects of the lock.

A further objective of the current invention is to house the electrical aspects of the lock inside the safe enclosure away from the door.

Another objective of the current invention is to provide an electronic secure lock that does not require any wire harness on the door.

A further objective of the current invention is to provide a two part locking mechanism in which each part bounds the moving lock mechanism by brackets and reinforced safe wall features to significantly strengthen the locking system.

An additional objective of the current invention is to provide a safe lock solution that allows for the option of an electronic lock, a mechanical lock or the combination of electronic and mechanical locks. It will be noted that the above described objectives are exemplary and that all embodiments of the present invention need not achieve all of these objectives, and some embodiments may achieve further objectives and advantages not addressed herein.

A more complete understanding of the present invention, as well as further features and advantages of the invention, will be apparent from the following Detailed Description and the accompanying drawings.

### BRIEF DESCRIPTION OF THE DRAWINGS

FIG. 1 is a perspective view of an exemplary safe with which the current invention may be suitably used.

FIG. 2 is a perspective view of the safe of FIG. 1 with the doors removed.

FIG. 3 is an exploded view of a safe door employing one embodiment of the mechanical portion of the lock of the present invention.

FIG. 4 is a perspective cutaway view of a section of the safe showing the door with the mechanical portion of the lock in relation to an interior wall of the safe when the door is closed and the lock is unlocked.

FIG. 5 is a perspective cutaway view of the same section of the safe shown in FIG. 4 showing the door with the mechanical portion of the lock in relation to the interior wall of the safe when the door is closed and the lock is in the locked position.

FIG. 6 is a perspective cutaway view of the same section of the safe shown in FIG. 4 showing the door with the mechanical portion of the lock in relation to the interior wall of the safe when the door is closed and the lock is unlocked showing the position of the solenoid in the unlocked position.

FIG. 7 is a perspective cutaway view of a section of the safe showing the door with the mechanical portion of the lock in relation to the interior wall of the safe when the door is closed and the lock is in the locked position and the solenoid in the locked position.

FIG. 8 is a perspective view of a solenoid assembly suitable for use in conjunction with the current invention.

FIG. 9 is an exploded view of the solenoid assembly of FIG. 8.

FIG. 10 is an exploded view of a safe door in accordance with a second embodiment of the mechanical portion of the lock of the present invention in conjunction with bolt work bolts not shown for clarity of illustration.

FIG. 11 is an assembled view of the safe door of the second embodiment in accordance with the present invention illustrating the mechanical portion of the lock shown with the bolt work included.

FIG. 12 is a perspective view of the bolt work bolts of FIG. 11.

FIG. 13 is a perspective view of the mechanical bolt work lock assembly from the door side with the door removed and the key lock in the unlocked position.

FIG. 14 is a perspective view of the mechanical bolt work lock assembly from the door side with the door removed and the key lock in the locked position.

FIG. 15 is a perspective view of a section of the safe showing the door with the mechanical bolt work portion of the lock in relation to the interior wall of the safe when the door is closed and the bolt work is disengaged.

FIG. 16 is a perspective view of a section of the safe showing the door with the mechanical bolt work portion of the lock in relation to the interior wall of the safe when the door is closed and the bolt work is engaged.

FIG. 17 is a perspective view of a section of the safe showing the door with the mechanical bolt work portion of the lock in relation to the interior wall of the safe when the door is closed and the lock is unlocked showing the position of the solenoid in the unlocked position.

FIG. 18 is a perspective view of a section of the safe showing the door with the mechanical bolt work portion of the lock in relation to the interior wall of the safe when the door is closed and the lock is in the locked position and the solenoid in the locked position.

FIG. 19 is a perspective view of a motor assembly for an alternate embodiment of the current invention shown in the locked position.

FIG. 20 shows the motor assembly for an alternate embodiment of the current invention shown in the un-locked position.

FIG. 21 is an exploded view of the motor assembly for an alternate embodiment of the current invention.

FIG. 22 is a perspective view of a section of the safe showing the door with the mechanical bolt work portion of the lock in relation to the interior wall of the safe when the door is closed and the lock is unlocked showing the position of the motor assembly in the unlocked position.

FIG. 23 is a perspective view of a section of the safe showing the door with the mechanical bolt work portion of the lock in relation to the interior wall of the safe when the door is closed and the lock is in the locked position and the motor assembly in the locked position.

FIG. 24 shows an exemplary control circuit for controlling an electronic lock in accordance with the present invention.

FIG. 25 shows a security locking method in accordance with the present invention.

### DETAILED DESCRIPTION

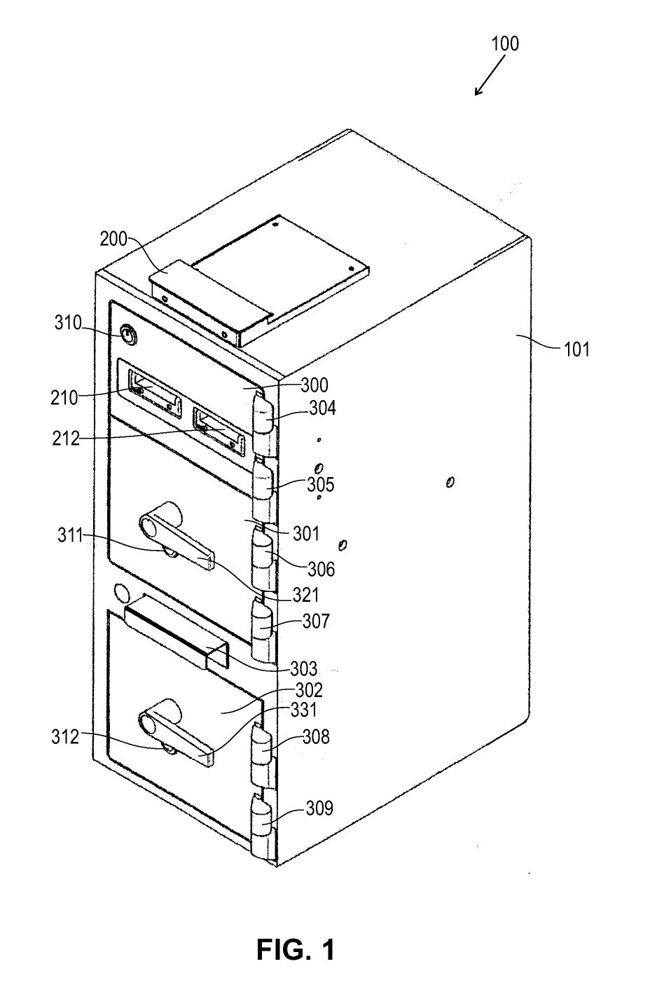

Referring to FIG. 1, an electronic safe 100 is shown including a safe housing 101, safe top door 300, safe center door 301 and safe bottom door 302. The electronic safe 100 also has a user keypad and display module 200 for users to enter their identification and other information as well as receive messages from the safe system. Further details of electronic safes and coin and bill dispensing safes with which the present invention may be advantageously employed are found in U.S. Patent Application Publication Nos. 2002/0063034; 2004/0046018; 2011/0279225; 2011/0011927; and U.S. Pat. Nos. 7,516,832; 7,779,983; and 8,770,372, all of which are assigned to the assignee of the present invention and incorporated by reference herein in their entirety.

In the preferred embodiment the electronic safe 100 houses electronic bill acceptors, 210 and 212, to allow bills to be deposited into the safe. The electronic safe will record the identity of the person depositing the bills as well as keep track of all currency in the safe. The safe also has an envelope drop drawer 303 which may be electronically controlled to allow for drops of bills and other items that cannot be accepted by the bill acceptors 210 and 212.

The electronic safe as shown in FIG. 1 contains three doors. The top door 300 is shown with key lock 310 and is used to allow access to the bill acceptors 210 and 212 and other electronics for service personnel. This door can be supplied with the key lock 310 as shown or with only an electronic lock to be discussed later or with both a key lock and an electronic lock. If an electronic lock is used, the required code to unlock the door will be entered through the keypad 200.

The center door 301 is used to house the bill cassettes associated with the bill acceptors 210 and 212. This door is also shown with a key lock 311. The center door can be supplied with the key lock as shown or with only an electronic lock to be discussed later or with both a key lock and an electronic lock. As in the top door 300, if an electronic lock is used, the required code to unlock the door will be entered through the keypad 200.

The bottom door 302 is used to access the envelope dropped through the envelope drop drawer 303. The bottom door 302 is shown with key lock 312 and can be supplied with an electronic lock or both a key and electronic lock. Similar to the top and center doors 300 and 301, if an electronic lock is used, in one embodiment, the bottom door 302 will require a code to be entered through the keypad 200 to open. Alternatively, a code might be transmitted from an authorized user's identification badge or tag, an authorized user's cellphone, or the like.

The center and bottom doors, 301 and 302 have included bolt work which will be described in more detail below. When using bolt work, handles 321 and 331 are employed to control the movement of the bolts when the key and/or electronic locks are unlocked. The details of this operation will be described below.

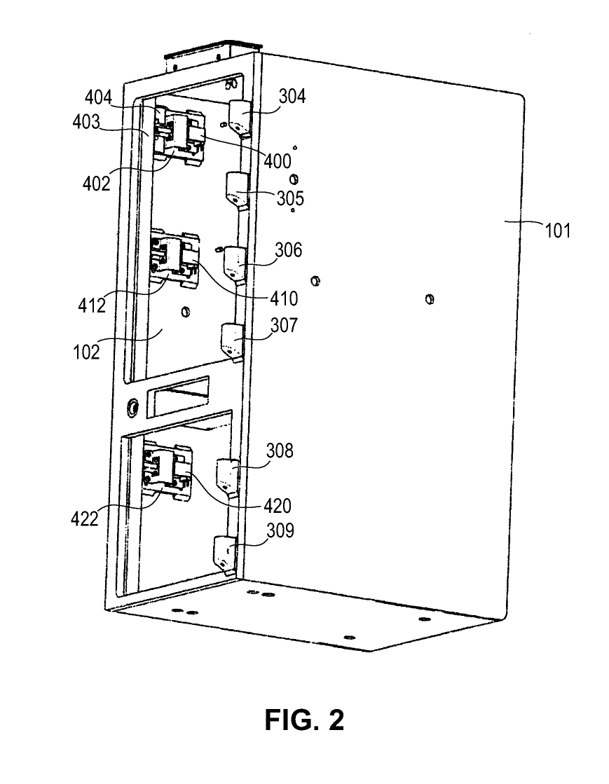

FIG. 2 shows the electronic safe housing 101 with the doors and internal components, such as the bill validators and cassettes, removed. Mounted on the inside wall 102 opposite the bottom half of door hinges 304, 305, 306, 307, 308, 309, solenoid assemblies 400, 410, 420 are shown. These solenoid assemblies are mounted on reinforced brackets 402, 412, 422 respectively which are welded to the inside wall 102 and constitute the electrical portion of the lock assemblies of the current invention. The positions of the solenoid assemblies 400, 410, 420 are arranged to allow mating with corresponding mechanical lock assemblies mounted on the doors to be discussed further below.

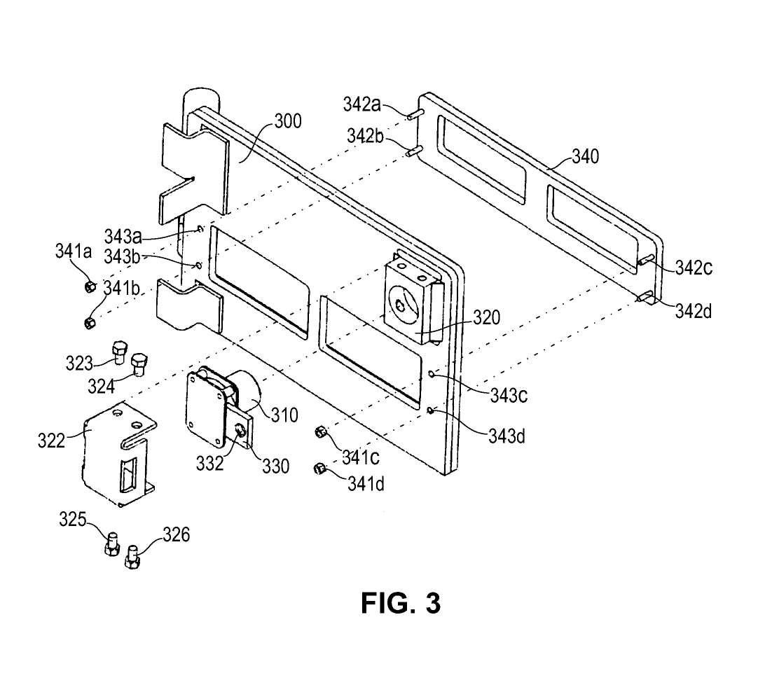

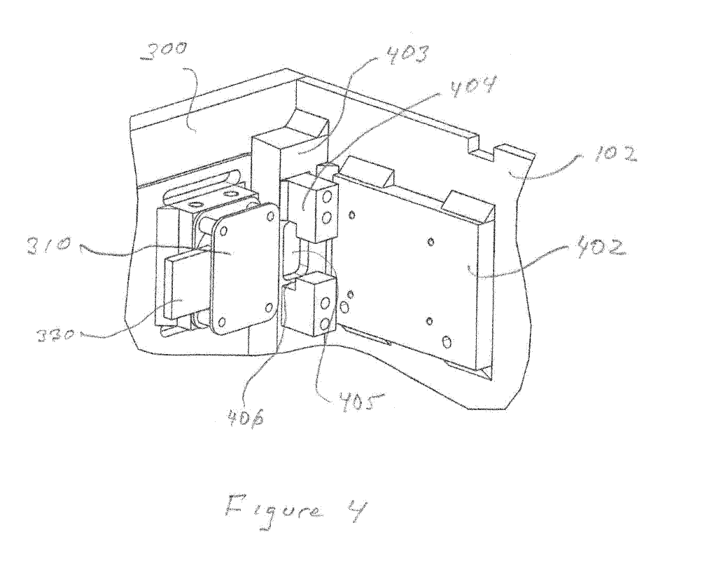

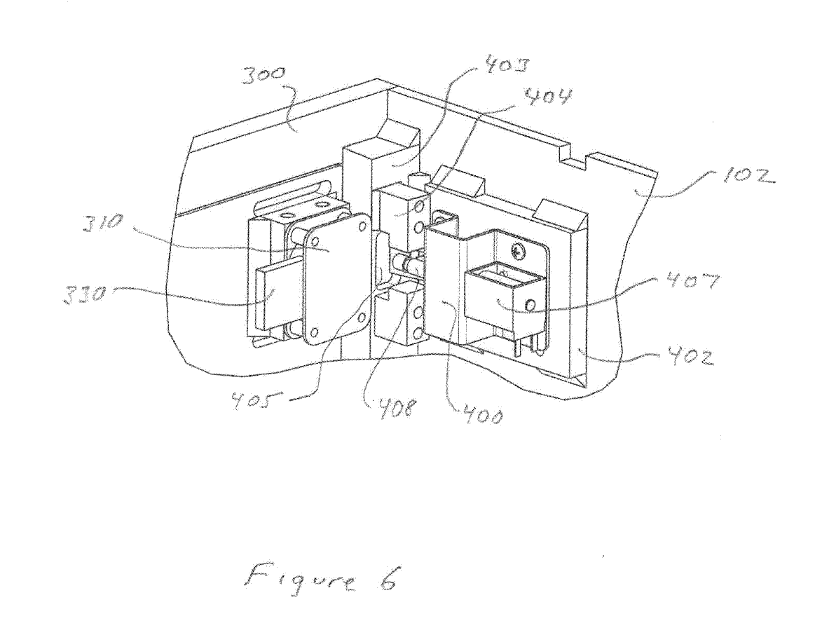

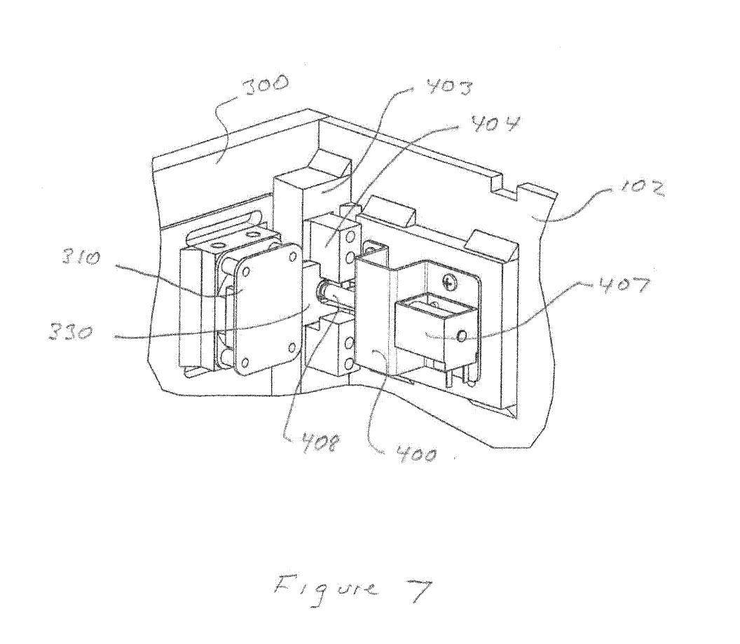

FIG. 3 shows an exploded view of the top door 300. Key lock 310, such as Medeco model 96W0397 T--26-S6 modified as addressed herein, is mounted to a reinforced bracket 320 welded onto door 300. In order to protect against an attempt to knock the lock 310 through the door 300, or an attempt to pry the door open, an additional protective cover 322 is mounted over the lock 310 and bolted to the reinforced lock bracket 320 with hardened steel bolts 323, 324, 325, 326 as shown. Lock 310 has locking tongue 330 which when in the locked position is extended beyond the end of the door 300 to grasp the safe enclosure 101 as discussed below in connection with FIGS. 4-7. Lock tongue 330 has been modified to include a hole 332 positioned thereon so that when assembled to the safe enclosure 101, and in the locked position, the hole 332 aligns with the solenoid plunger 408 of the lock assembly as shown in FIGS. 6 and 7.

The top door 300 also includes a top door bill acceptor plate 340, which contains clearance apertures for the bill acceptors 210, 212 to insure a variety of bill acceptor 210, 212 options can be used. The location of the bill acceptor 210, 212 ingress positions vary between bill acceptor manufacturers and options selected. The bill acceptor plate 340 limits the ingress openings shown in the top door 300. A presently preferred manufacturing approach to the top door is to use two sheets of metal each approximately half the total thickness required welded together to produce the final door thickness. In this embodiment the thickness would be ½″ total, so two ¼″ steel plates would be welded together. This arrangement allows for the bill acceptor plate 340 to be made using ¼″ steel so the total thickness of the door remains ½″ when the bill acceptor plate 340 is installed. The bill acceptor plate 340 is shown having four mounting studs 342a, 342b, 342c, and 342d which pass through the top door 300 through holes 343a, 343b, 343c, 343d and held in position with nuts 341a, 341b, 341c and 341d.

FIG. 4 shows the relationship between top door 300 and the inside wall of safe enclosure 102 when the top door 300 is in the closed position. The top door lock 310 is shown mounted to the top door 300 with the top door reinforced lock mounting cover 322 omitted for clarity. The lock tongue 330 is shown in the unlocked position. Top door reinforced solenoid assembly mounting bracket 402, also shown in FIG. 2, is shown with additional detail. The solenoid assembly is omitted for clarity.

The safe enclosure 101 contains a reinforced lock latching bar 403 as seen in FIG. 2 and FIG. 4. This bar 403 provides an additional steel thickness at least as great as the door thickness for the locking mechanism to latch behind as will be described later. The locking method for the top door 300 using the top door lock 310 also includes a reinforced top door tongue latching assembly 404 with a tongue latching assembly clearance slot 406 to which the lock tongue 330 is positioned when the top door lock 310 is in the locked position. An electric lock clearance 405 is provided to allow the electric lock assembly to latch the top door lock 310 as will be described below.

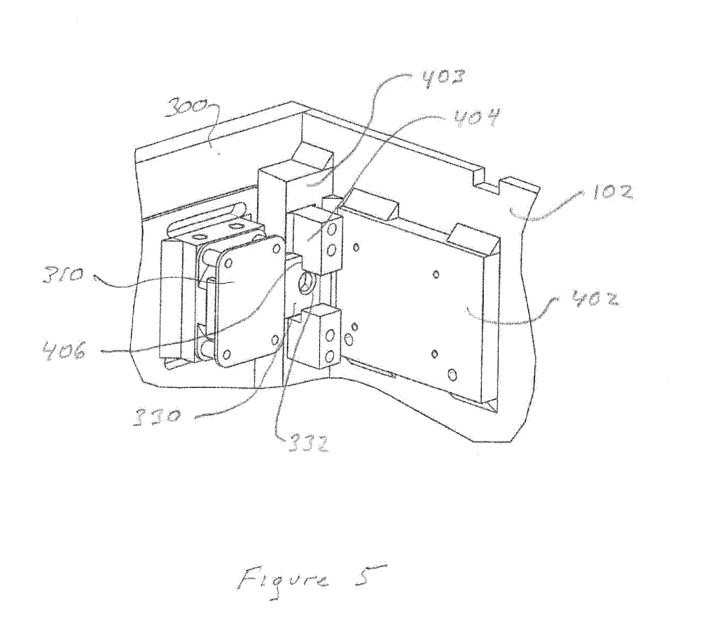

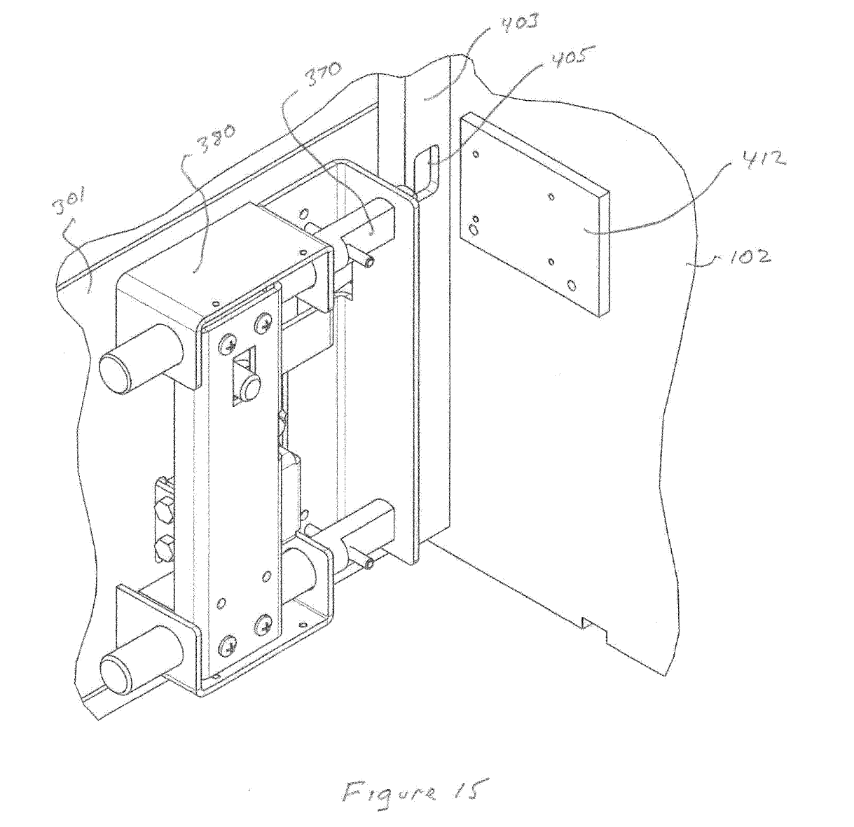

FIG. 5 shows the same relationship between the top door 300 and the inside wall of safe enclosure 102 as seen in FIG. 4, but with the top door lock 310 in the locked position. In FIG. 5, the lock tongue 330 is held in place by the top door tongue latching assembly 404. The lock tongue 330 fits in the tongue latching assembly clearance slot 406 such that even in the absence of an electric lock assembly 400, attempts to pry open the door would be difficult as the lock tongue 330 would have to be substantially deformed to escape the top door tongue latching assembly 404. The lock tongue hole 332 aligns with the electric lock clearance hole 405 shown in FIG. 4 and also seen in FIG. 15.

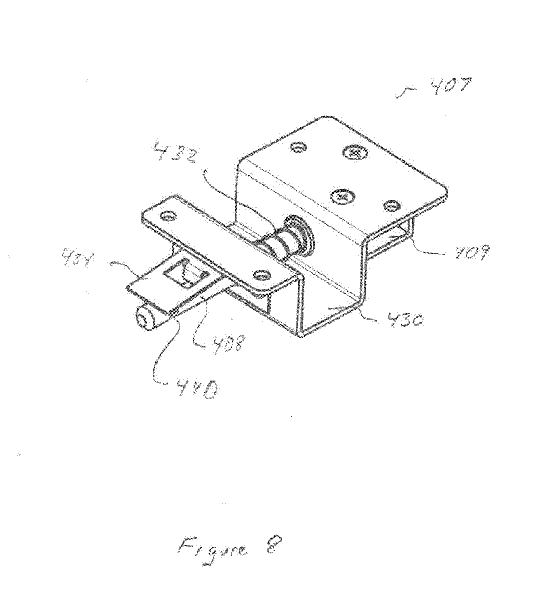

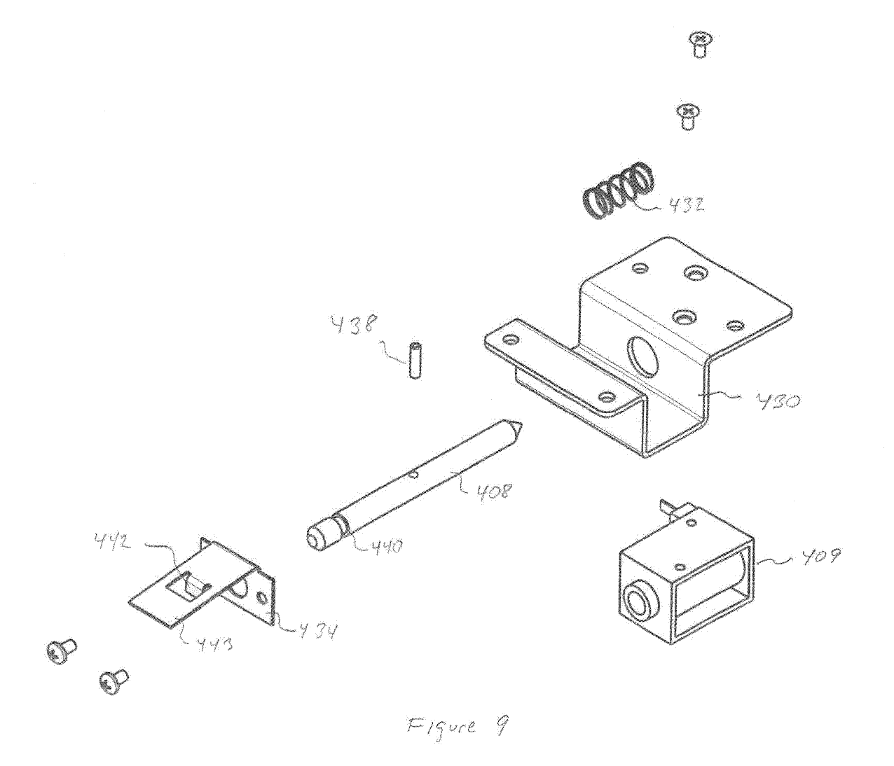

FIG. 6 shows the relationship between the top door 300 and the inside wall of the safe enclosure 102 with the top door lock 310 in the unlocked position. The electric lock assembly 400 is shown mounted to the top door reinforced solenoid assembly mounting bracket 402. The electric lock assembly 400 includes a solenoid assembly 407 and a solenoid plunger 408 seen in further detail in FIGS. 8 and 9. The electric lock assembly 400 is shown in its unlocked position. The solenoid assembly 407 is positioned so that the solenoid plunger 408 is aligned with the electric lock clearance 405. When the electric lock assembly 400 is in the locked position, the solenoid plunger 408 will be extended through the hole 332 in the lock tongue 330 and into the electric lock clearance hole 405.

The locked top door lock 310 and locked electric lock assembly 400 are best seen in FIG. 7. The solenoid plunger 408 is shown extending through hole 332 in the lock tongue 330 and into the electric lock clearance 405. While the electric lock assembly 400 is in the locked position as shown in FIG. 7, the top door lock 310 cannot be opened even if the key is used. The solenoid plunger 408 locks the lock tongue 330 in place. Further, any attempt to forcibly turn the key will not bend or break the solenoid plunger 408 as it is embedded in the reinforced top door tongue latching assembly 403 by electric lock clearance 405.

The electric lock assembly 400 is described in more detail with reference to FIGS. 8 and 9. The electric lock assembly 400 contains the solenoid assembly 407. Solenoid assembly 407 includes solenoid 409 which is mounted to solenoid assembly bracket 430. Spring 432 is assembled to the solenoid plunger 408 and solenoid assembly 409 and held in place with solenoid spring retaining pin 438. Spring 432 is selected to allow ample force on the solenoid plunger 408 through the retaining pin 438 to insure a quick, strong throw of the solenoid plunger 408 through the various door lock assemblies used. The typical operation of a solenoid is to have the solenoid plunger 408 extended when the solenoid 409 is not powered and to have the solenoid plunger 408 in its retracted position when the solenoid 409 is energized. When energized, spring 432 is in its compressed state. However, this would result in excess power being applied to keep the solenoid in its compressed state.

In order to minimize the power required in the compressed state, solenoid detent bracket 434, preferably made from spring steel, has a solenoid bracket detent 442 that aligns with solenoid plunger detent slot 440 to latch the solenoid plunger 408 in its compressed state. Power can be removed and the solenoid will remain in this state. When the lock tongue 330 is engaged through the reinforced top door tongue latching assembly 404, it presses against the solenoid detent release 443, pushing the solenoid detent bracket 434 away from plunger 408 allowing the solenoid bracket detent 442 to release the plunger 408. The spring 432 extends forcing the plunger 408 through the solenoid tongue hole 332. Thus, when a safe door, such as top door 300, center door 301 or bottom door 302 is by a corresponding handle being moved to a closed position or a manual lock being keyed closed, the corresponding electronic lock will automatically relock.

The operation of the top door electronic lock assembly 400 and the top door lock 300 can be applied in combination or individually with the option to enhance the security by starting with one and adding the other. In particular, the top door lock 300 can be used without a key by replacing it with a handle to engage the lock tongue 330 into the tongue latching assembly clearance slot 404 as described above. The top door electric lock assembly 400 alone can provide secure locking. Alternatively, the top door lock 300 with a key can be used without the electric lock assembly 400 alone to provide secure locking. The combination of using both a key lock and the electric lock, however, provides several advantages. Among these is significantly enhanced security, dual authority, such as key and electronic code, to gain access, and the ability to control acceptable access times for key access by programming the electronic lock to be unlocked during selected times. Additionally, the wiring and access to the electric lock is on the inside of the safe as opposed to the door further increasing security and reliability.

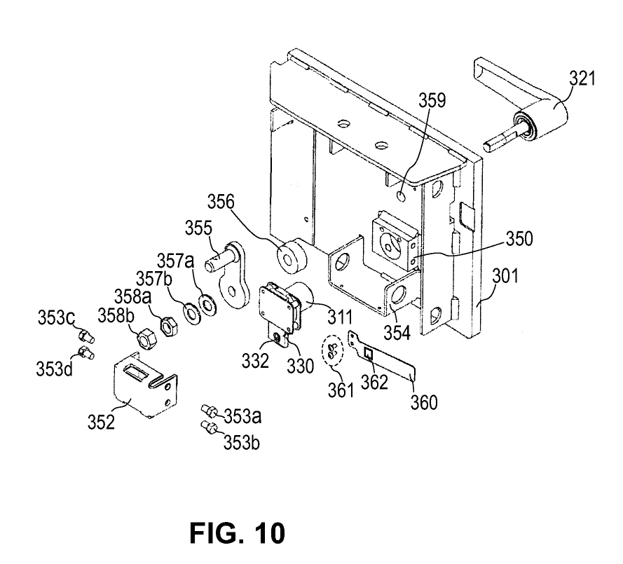

The current invention is also applicable to the more conventional bolt work arrangements traditionally used in security safes. FIG. 10 illustrates an exploded view of a partial construction of a center door 301 using a center door lock 311 in the construction of a bolt work arrangement. Center door 301 includes center door reinforced lock mounting assembly 350 welded thereon. The center door lock 311 is mounted to the center door reinforced lock mounting assembly 350 and secured by center door reinforced lock mounting cover 352 with hardened bolts 353a, 353b, 353c and 353d.

The center door handle 321 is mounted to the center door 301. Center door handle 321 passes through center door 301 handle mounting clearing hole 359 and handle spacer 356, through center door bolt pivot arm 355 and fastened with handle mounting washers 357a and 357b and handle jam nuts 358a and 358b. The center door bolt pivot arm 355 will be used to move the bolt work from the locked to unlocked position as described later.

The bolt work will be triggered by the spring steel center door bolt release latch 360. This latch 360 is mounted to the center door 301 with center door bolt release latch mounting screws 361.

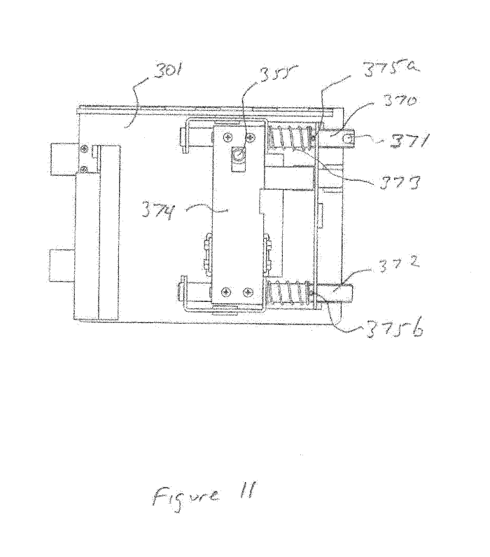

The bolt work bracket 374 is mounted to center door 301 as best seen in FIG. 11. Mounted to the bolt work bracket 374 are an engaging bolt 370 and a standard bolt 372. The bolt work bracket 374 insures all the bolts in the assembly (two are shown in the embodiment of FIG. 11) are linked together and move as one. Spring 373 is mounted on the engaging bolt 370, the standard bolt 372 or both and held in place with retaining pins 375a and/or 375b. Of course it is understood the spring(s) can be otherwise configured. For example, an extension spring can be suitably employed rather than compression springs held between the bolt work bracket 374 and the center door 301. The engaging bolt 370 has an engaging bolt solenoid clearance hole 371 which engages with the inside wall of safe enclosure 102 as discussed below.

The bolt work bracket 374 and the assembled parts described above are moveable when center door handle 321 is pivoted causing center door bolt pivot arm 355 to move laterally. So long as the center door lock 311 is in the unlocked position, the bolt work is free to move.

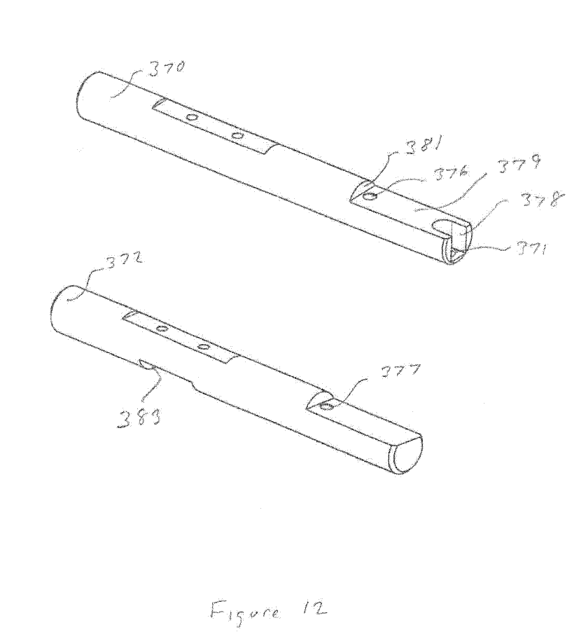

The characteristics of the engaging bolt 370 and the standard bolt 372 are best understood with reference to FIG. 12. The standard bolt 372 is preferably a solid cylindrical steel member with standard bolt retaining pin hole 377. The standard bolt flat 383 provides a channel for the lock tongue 330 to be used to lock the bolt work mechanically in the locked position as described below. The engaging bolt 370 is similarly a solid cylindrical steel member. In the case of the engaging bolt 370 it is important to have the orientation correct so the mating solenoid is properly aligned. To achieve this, an engaging bolt orientation flat 379 is provided. It will be appreciated that the engaging bolt stop 381 along with an associated orientation flat can be included on any of the bolts associated with the bolt work assembly 380. The engaging bolt retaining pin hole 376 for retention of the spring, is provided as well. Insofar as the engaging bolt 370 is to mate with the solenoid plunger, a generous engaging bolt solenoid clearance slot 378 insures no interference will occur. The engaging bolt solenoid clearance hole 371 provides the opening through which the solenoid plunger will pass and lock the engaging bolt 370 as will be described below.

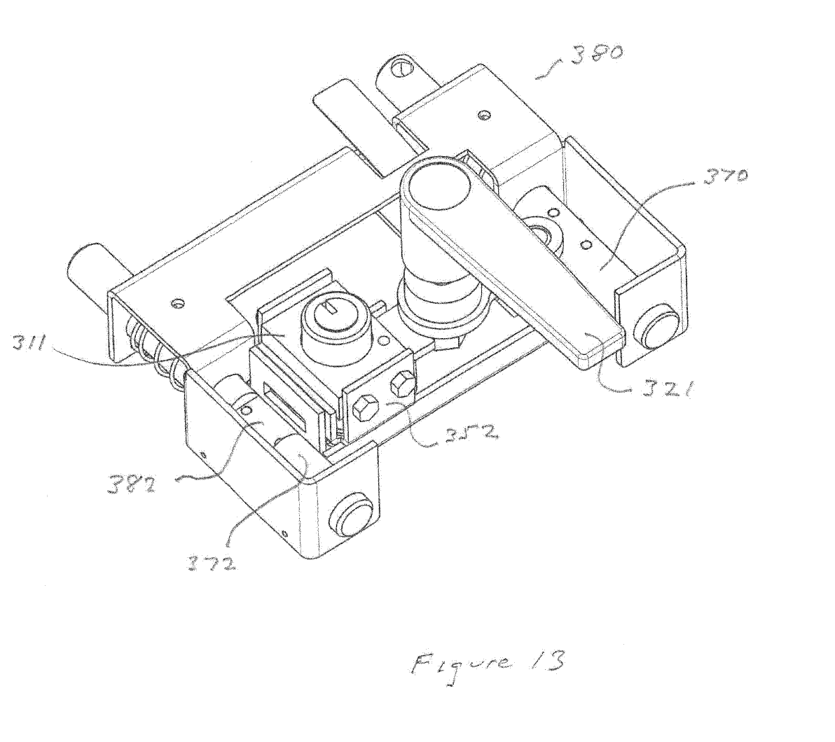

FIG. 13 shows the bolt work assembly 380 from the door side with the door removed for clarity of illustration. If the door were shown, it would be seen that handle 321 and key lock 311 protrude through the door. Engaging bolt 370 and standard bolt 372 are shown with the locking ends nearer the top of the FIG. 13. In this configuration, the engaging bolt stop 382 is shown on standard bolt 372 and can be seen aligned with the retracted lock tongue 330. The bolts 372 and 370 are free to move with the motion of the handle 321 in one of a number of ways beyond the scope of this patent.

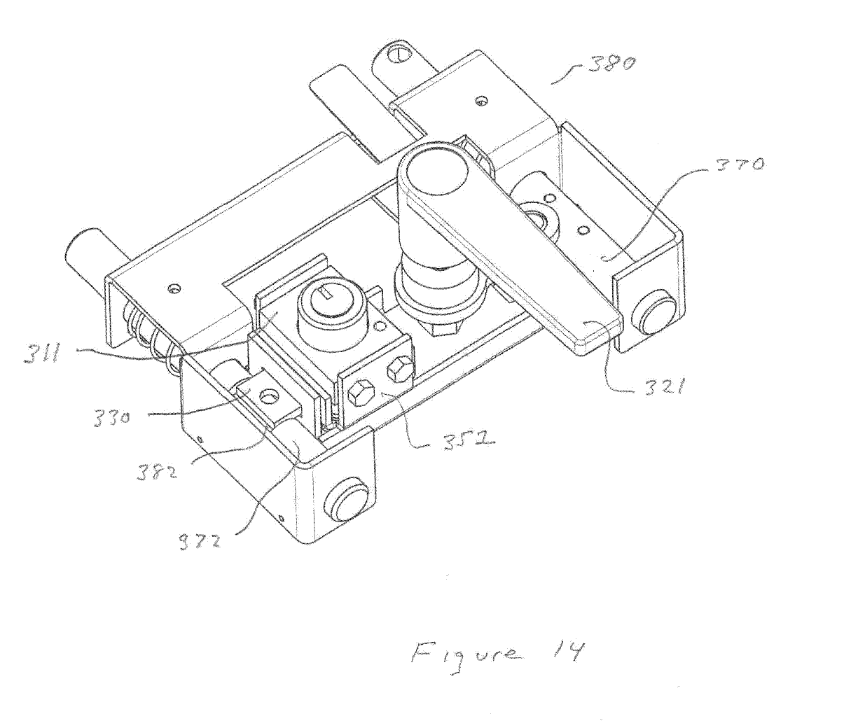

FIG. 14 shows the bolt work assembly 380 also from the door side with the door removed for clarity. In this view, lock tongue 330 is shown in its engaged position holding standard bolt 372 in place against the engaging bolt stop 382. In this position, the bolts cannot be moved.

FIG. 15 shows the relationship between center door 301 and the inside wall of safe enclosure 102 when the center door 301 is in the closed position. The engaging bolt 370 is shown in the unlocked position. Center door reinforced solenoid assembly mounting bracket 412, also shown in FIG. 2, is shown with additional detail. The solenoid assembly is omitted for clarity.

The reinforced lock latching bar 403 provides an additional steel thickness at least as great as the door thickness for the locking mechanism to latch behind as will be described below.

An electric lock clearance slot or hole 405 is provided to allow the electric lock assembly to latch the center door engaging bolt 370 as will be described below.

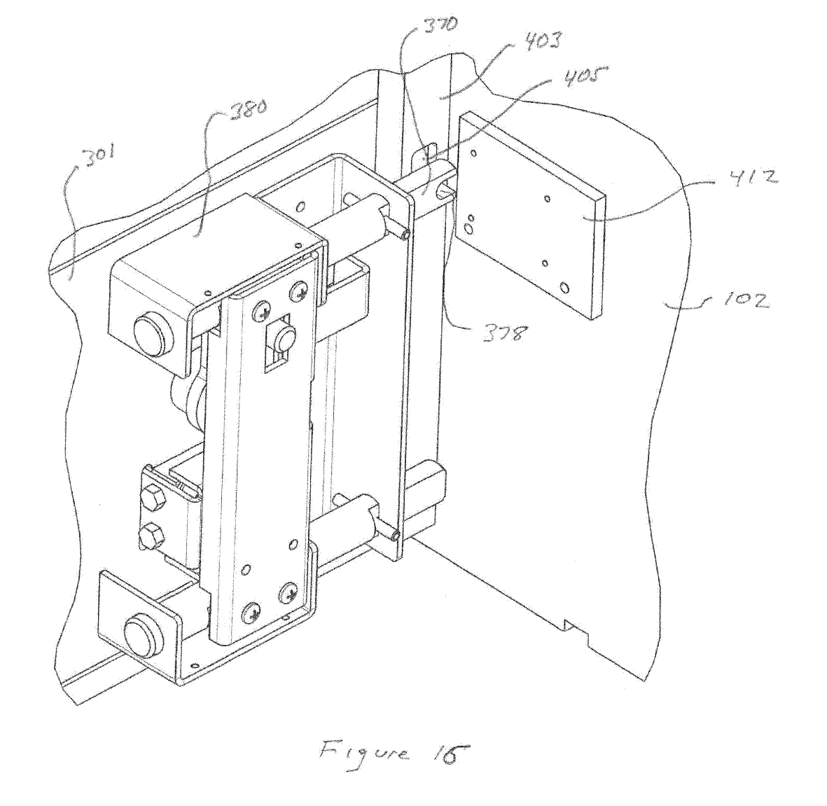

FIG. 16 shows the same relationship between center door 301 and the inside wall of safe enclosure 102 as FIG. 15, but with the center door lock 311 in the locked position. The engaging bolt 370 fits in the clearance 405 against the reinforced lock latching bar 403 insuring attempts to pry open the door would be difficult as the engaging bolt 370 would have to be deformed to clear the lock latching bar 403. The engaging bolt solenoid clearance slot 378 aligns with the electric lock clearance 405 shown in FIG. 16 to receive the solenoid plunger 408 of the center door solenoid assembly 410 as further described below.

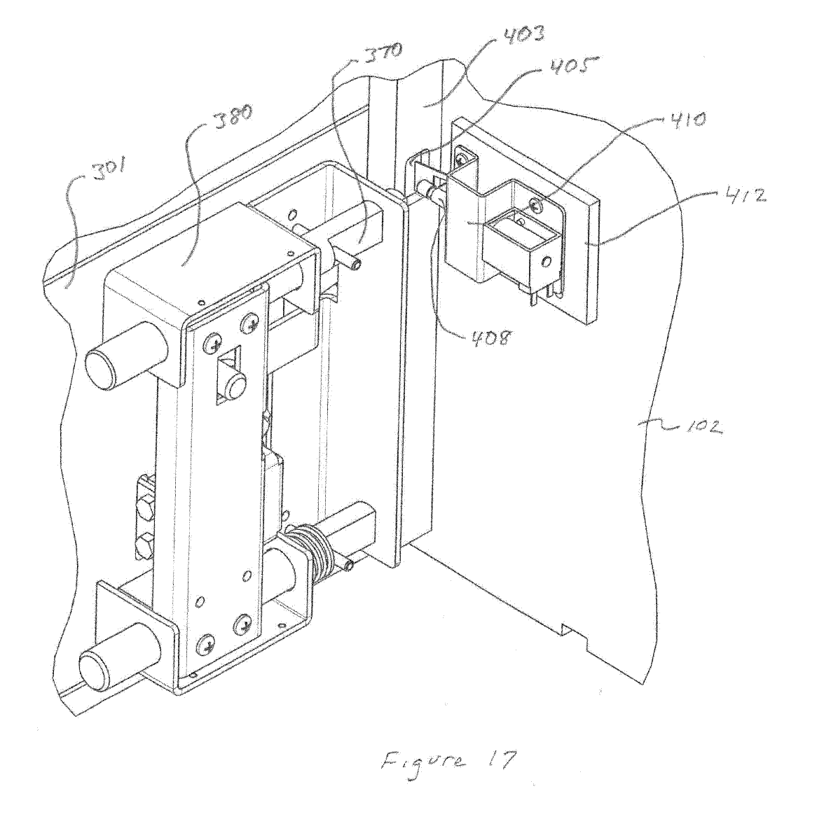

FIG. 17 shows the relationship between the center door 301 and the inside wall of the safe enclosure 102 with the center door lock 311 in the unlocked position. The center door solenoid assembly 410 is shown mounted to the center door reinforced solenoid assembly mounting bracket 412. The center door solenoid assembly 410 is shown in its unlocked position. The solenoid assembly 410 is positioned to allow the solenoid plunger 408 to align with the electric lock clearance 405. When the solenoid assembly 410 is in the locked position, the solenoid plunger 408 will be extended through the engaging bolt solenoid clearance slot 378 and the engaging bolt solenoid clearance hole 371 seen in FIG. 12 and into the electric lock clearance 405.

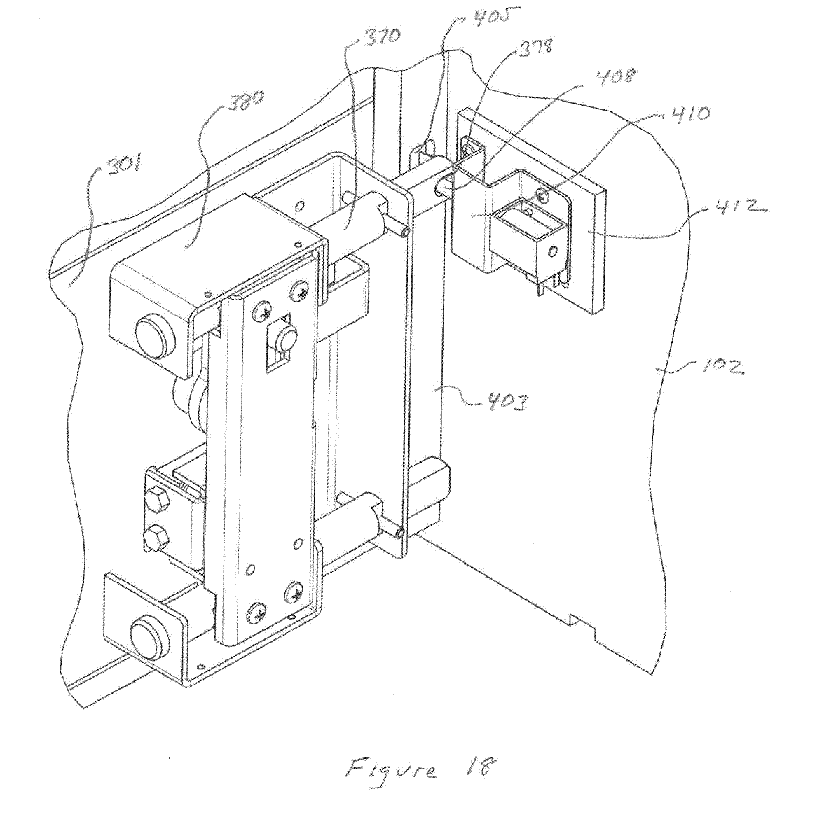

The locked center door lock 311 and locked center door solenoid assembly 410 is best seen in FIG. 18. The solenoid plunger 408 is shown extending through the engaging bolt 370 and into the electric lock clearance 405. While the center door solenoid assembly 410 is in the locked position, center door lock 311 cannot be opened even if the key is used. The solenoid plunger 408 locks the engaging bolt 370 in place. Further, any attempt to forcibly turn the key will not bend or break the solenoid plunger 408 as it is embedded in the reinforced tongue latching assembly 403 and held by electric lock clearance 405. The solenoid plunger 408 when in the locked position is held at one end by the solenoid bracket assembly 430 best shown in FIG. 8 and the door lock clearance 405. Therefore if any force is exerted on the door in an attempt to pry the door open, the solenoid plunger 408 has limited exposure to bending or dislodging.

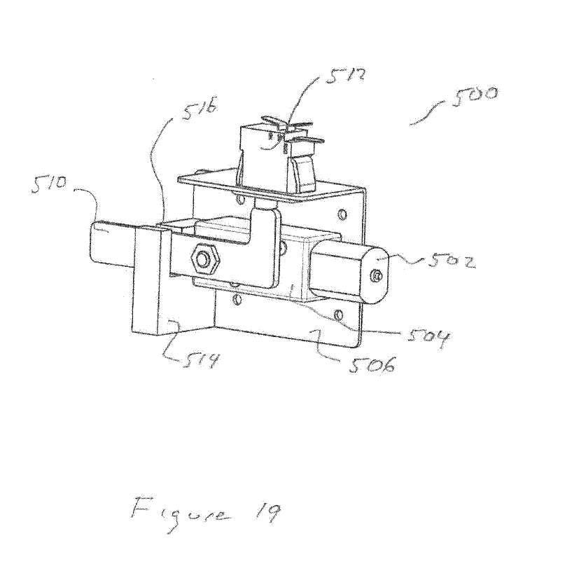

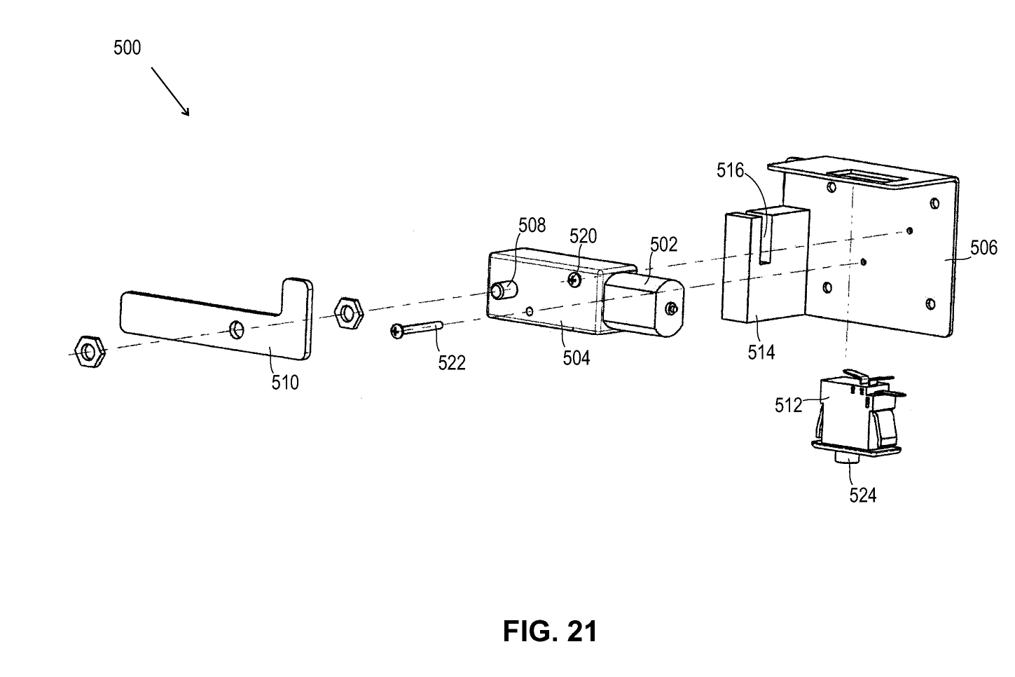

In an alternate embodiment of the current invention, a motor assembly 500 can be used instead of a solenoid assembly as shown in FIG. 19. A motor 502 together with a motor gear assembly 504 is mounted to motor bracket 506. Motor cam lever 510 is mounted to motor drive shaft 508 best shown in FIG. 21 and is rotatable around motor drive shaft 508 as the motor is energized. Changing the polarity of the drive to the motor changes the rotation direction of the motor cam lever 510. The method of driving the motor is not shown and is well known in the art. Motor position switch 512 is mounted to motor bracket 506 so that the motor position switch is in the closed position when the motor cam lever 510 is in the locked position as described below. Of course, an alternate to the motor position switch 512 can be used such as an optical or magnetic switch and additional position sensing can be added to also monitor the unlock position of the motor cam lever 510.

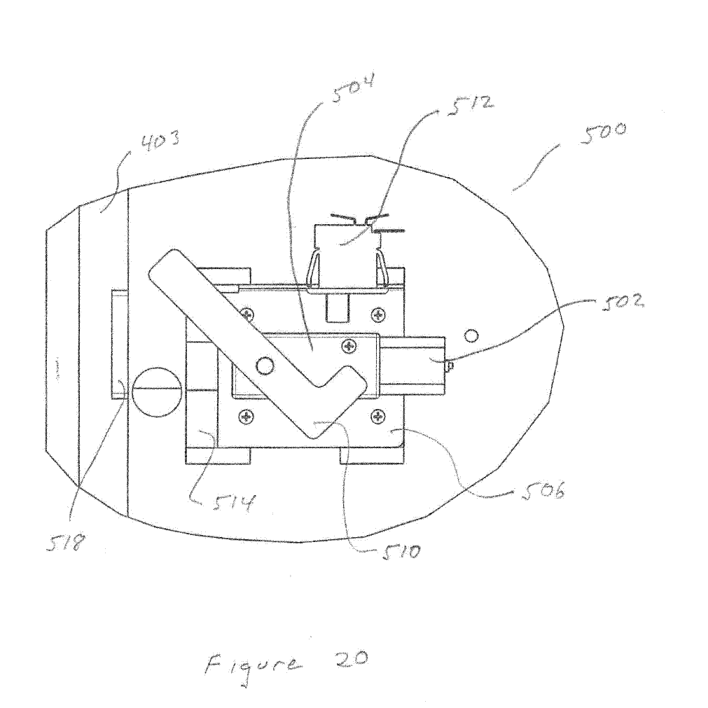

When the motor cam lever 510 is in the locked position, it is trapped within the motor bracket support slot 516 of the motor bracket support block 514 as shown in FIG. 19. In the unlocked position best shown in FIG. 20, the motor cam lever 510 clears the motor bracket support slot 516. The relationship between the motor cam lever 510 and the various types of door locks will be discussed below in reference to the center door lock 311 below. FIG. 20 also shows the relationship of the motor assembly 500 and the reinforced lock latching bar 403. Motor cam lever clearance slot 518 allows the motor cam lever 510 to be secured within the reinforced lock latching bar 403 when in the locked position. This arrangement prevents the motor cam lever 510 from being forcibly moved from its locked position as it is held between the reinforced lock latching bar 403 and the motor bracket support block 514.

FIG. 21 shows an exploded view of the motor assembly 500. Motor bracket 506 is used to mount the various components of this assembly as shown. The motor 502 is preassembled with the motor gear assembly 504 such that when the motor is energized, the motor drive shaft 508 rotates providing the torque required to rotate the motor cam lever 510. The motor 502 and motor gear assembly 504 is mounted to the motor bracket 506 using first motor mount screw 520 and second motor mount screw 522. When assembled, the motor cam lever 510 is rotatable about the motor drive shaft 508 allowing the motor cam lever 510 to rotate in and out of motor bracket support slot 516 in motor mount support block 514. Motor position switch 512 is mounted at the top of motor bracket 506 so that the motor cam lever 510 pushes the motor switch position plunger 524 when in the locked position. As noted earlier, additional switches or sensors can be added to detect other positions of the motor cam lever 510 as well.

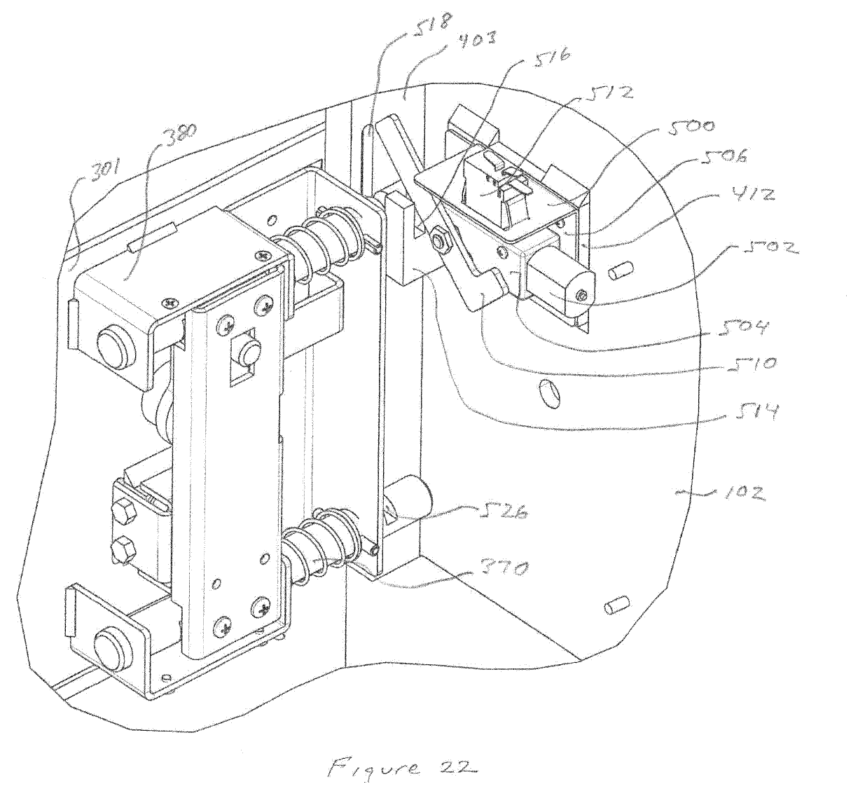

FIG. 22 shows the relationship between the center door 301 and the inside wall of the safe enclosure 102 with the center door lock 311 shown in FIG. 14 in the unlocked position. The motor assembly 500 is shown mounted to the center door reinforced mounting bracket 412. The motor assembly 500 is shown in its unlocked position. The motor assembly 500 is positioned so that the motor cam lever 510 is aligned with the motor cam latch clearance slot 518. When the motor assembly 500 is in the locked position, the motor cam lever 510 will be extended through the bolt lever engaging slot 526 shown for clarity on the lower bolt and into the motor cam latch clearance slot 518.

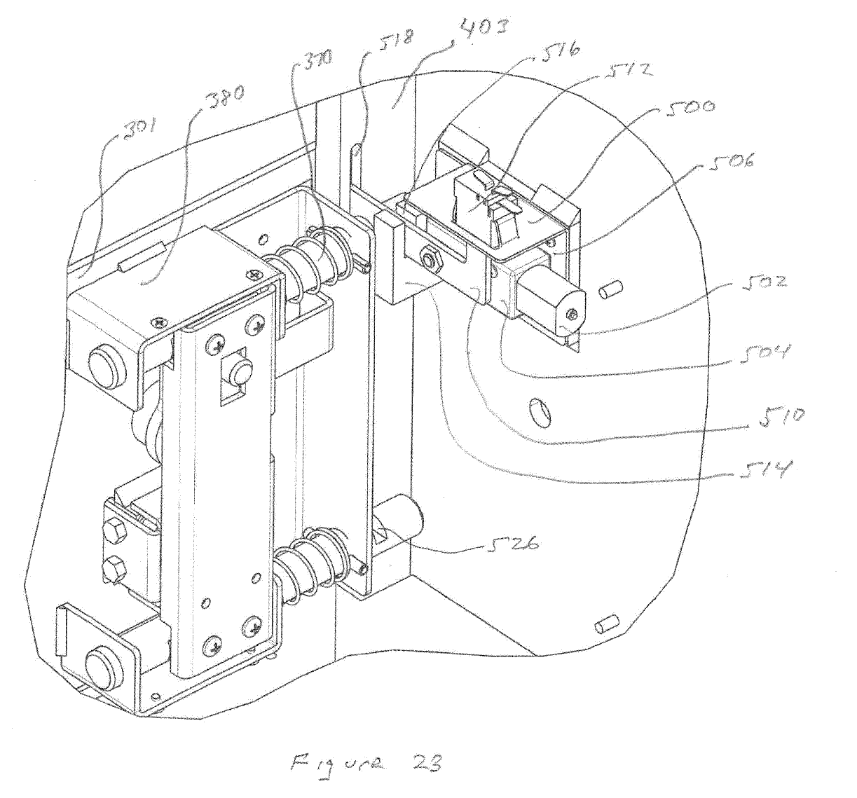

The locked center door lock 311 shown in FIG. 14 and locked motor assembly 500 is best seen in FIG. 23. The motor cam lever 510 is shown extending through the engaging bolt 370 and into the motor cam latch clearance slot 518. While the motor assembly 500 is in the locked position, center door lock 311 shown in FIG. 14 cannot be opened even if the key is used. The motor cam lever 510 locks the engaging bolt 370 in place. Further, any attempt to forcibly turn the key will not bend or break the motor cam lever 510 as it is embedded in the motor cam latch clearance slot 518. The motor cam lever 510 when in the locked position is held at one end by the motor bracket support block 514 through the motor bracket support slot 516 and the motor cam latch clearance slot 518. Therefore, if any force is exerted on the door in an attempt to pry the door open, the motor cam lever 510 has limited exposure to bending or dislodging.

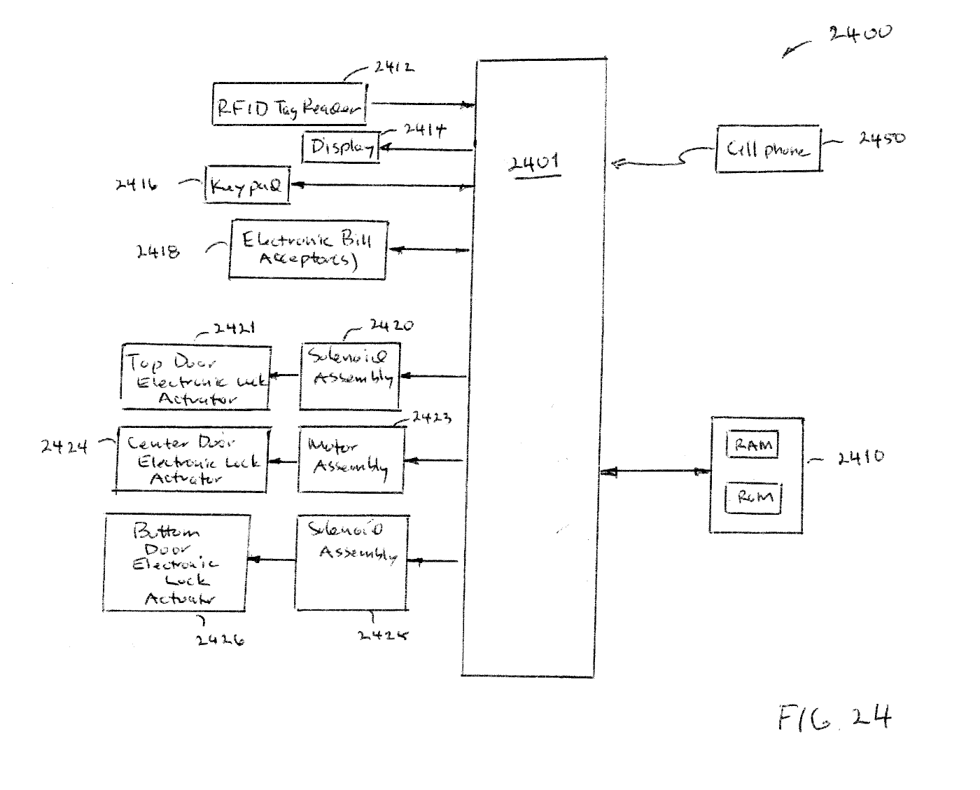

FIG. 24 shows an exemplary electronic control system 2400 including a programmed processor 2401 which receives inputs from an RFID tag reader 2412, a keypad 2416, electronic bill acceptor or acceptors 2418, as well as, a cell phone 2450. Software instructions and data, such as, authorized personnel identification data, a sequence of keypad presses or the like, are stored in memory 2410.

Processor 2401 provides drive inputs to display 2414, the electronic bill acceptor 2418, solenoid assembly 2420, motor assembly 2422, and solenoid assembly 2425. While a separate display 2414 and keypad 2416 are shown in FIG. 24, it will be recognized that a combined display and keypad, such as an LCD touchscreen may be suitably employed. Solenoid assembly 2420 unlocks a first electronic lock 2421, such as the top door electronic lock. Motor assembly 2422 unlocks a second electronic lock 2423, such as the middle door electronic lock. Solenoid assembly 2425 unlocks a third electronic lock 2426, such as the bottom door electronic lock.

In operation, an authorized operator such as a convenience store checkout clerk working with an electronic drop safe, a store manager, or the like, enters a sequence of keypad presses utilizing the keypad 2414. The processor 2401 compares the sequence with one or more sequences retrieved from storage in memory 2410. Alternatively, the authorized person may wear an RFID tag bracelet or the like read by an RFID tag reader 2402 to open the electronic locks of the electronic drop safe. A further alternative is the authorized person may enter the sequence using a cellphone, such as the cellphone 2450 to communicate the sequence to processor 2401.

In one electronic drop safe employing both a manual lock and an electronic lock, a second authorized person, such as an armored safe company employee charged with picking up cash from the electronic drop safe may also be required to employ a key to open the manual lock.

After cash has been picked up, the safe door is closed and the key is used to lock the manual lock. As addressed above, in connection with FIGS. 8 and 9, upon locking the manual lock, lock tongue 330 is engaged and pushes solenoid detent bracket 442 to release plunger 408, and automatically relock the electronic lock.

It will be recognized that with a simple choice of a door including a key lock or not, one safe design can support an electronic lock or an electronic lock in a combination with a manual key lock.

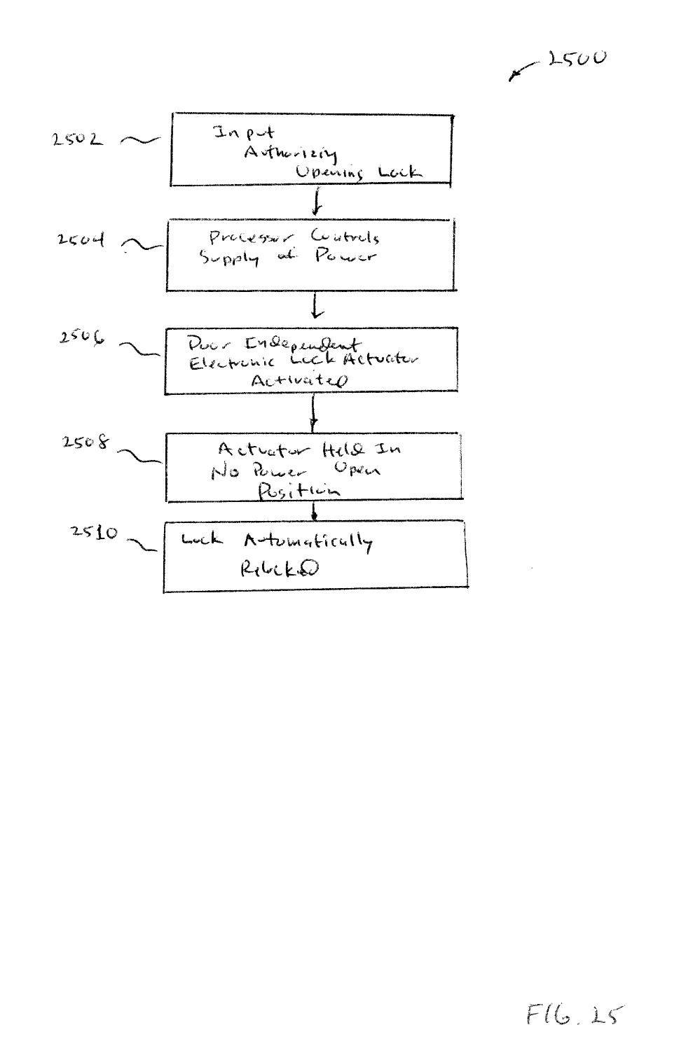

FIG. 25 shows an exemplary process 2500 for electronically locking a safe. In step 2502, a processor such as the processor 2401 of FIG. 24 receives an input authorizing opening of an electronic lock. The processor is preferably located inside an electronic drop safe or other safe and is independent of any door of the safe. In this context, independent means it is not mounted in or on the door of the safe.

In step 2504, the processor controls the supply of necessary power to an electronic lock actuator. For example, a processor, such as processor 2401 drives solenoid assembly 2420 or 2426 or motor assembly 2420. Such an arrangement comprises a door independent power arrangement in which no battery is in the safe door that provides lock activation power, no wires deliver power to the door, and no transmission of power is made to a receiver in the door to provide lock activation power.

In step 2506, a door independent electronic lock actuator is activated to open an electronic lock. For example, solenoid assembly 2420 activates a solenoid to unlock electronic lock 2421. The electronic lock activation is preferably mounted on one of the walls of the safe. In this context, a door independent activator is one that is not physically mounted on or in the safe door.

In step 2508, the solenoid is held in a spring loaded open position by a holding mechanism, such as solenoid detent bracket 442.

In step 2510, upon opening and then reclosing the safe door, the electronic lock is automatically relocked by releasing the holding mechanism resulting in a physical element such as engaging bolt 370 or solenoid plunger 408 to engage with a retention member of the safe door, such as bolt retaining hole 377 or plunger retaining hole 440.

It will be clear that there are numerous configurations and embodiments possible using the technology and techniques described above. While the present invention is disclosed in the context of presently preferred embodiments, it will be recognized that a wide variety of implementations may be employed by persons of ordinary skill in the art consistent with the above discussion and the claims which follow below.

1. An electronic lock and safe combination comprising:
a door;
a safe housing enclosing a secure storage space accessed by unlocking the door;
a door mounted member employed to move an internal member inside the safe from a locked position to an unlocked position;
a door independent electronic controller providing a control signal to control unlocking of an electronic lock;
a door independent electronic lock actuator preventing the internal member from moving until said actuator is activated by the control signal to move from a closed position to an open position; and
a mechanical arrangement to hold said actuator in the open position until the door is opened and reclosed.

2. The electronic lock and safe combination of claim 1 wherein said electronic controller is mounted internal to the safe and physically separated from the door, and the control signal is provided to said actuator by a wired connection.

3. The electronic lock and safe combination of claim 1 wherein said actuator engages the internal member to lock the door.

4. The electronic lock and safe combination of claim 1 wherein said actuator comprises a solenoid assembly having a solenoid plunger which passes through a lock tongue hole in the internal member and into a clearance hole in a solenoid lock latching bar mounted to a side wall of the safe.

5. The electronic lock and safe combination of claim 1 wherein said mechanical arrangement to hold said actuator in the open position comprises a slot in a solenoid plunger of said actuator and a solenoid detent bracket.

6. The electronic lock and safe combination of claim 1 wherein said actuator comprises a solenoid assembly or a motor assembly.

7. The electronic lock and safe combination of claim 4 wherein the door mounted member comprises:
a lock cylinder which is key operated to turn the internal member which moves a lock tongue that mates with a lock latching bar.

8. The electronic lock and safe combination of claim 1 wherein the door mounted member is a door handle and the internal member is a deadbolt actuated by the door handle.

9. The electronic lock and safe combination of claim 1 wherein the door mounted member is a door handle and the internal member comprises a center door pivot arm, said electronic lock and safe combination further comprising:
a spring loaded bolt work including a bolt work bracket linking at least two spring loaded bolts together wherein the door handle when actuated moves the center door pivot arm to free said bolt work bracket.

10. The electronic lock and safe combination of claim 1 further comprising:
a keypad to enter a required code to unlock the door independent electronic lock.

11. The electronic lock and safe combination of claim 1 further comprising:
an electronic bill acceptor housed within the safe housing.

12. The electronic lock and safe combination of claim 11 further comprising:
a bill cassette associated with the electronic bill acceptor.

13. The electronic lock and safe combination of claim 4 wherein the solenoid assembly is mounted on a reinforced bracket welded to an inside wall of the safe housing.

14. The electronic lock and safe combination of claim 11 wherein the door further comprises:
a door bill acceptor plate which contains a clearance aperture for the bill acceptor.

15. The electronic lock and safe combination of claim 4 wherein the door is made of steel and has a thickness, and the internal member further comprises a reinforced lock latching bar made of steel at least as thick as the thickness of the door.
